(19) United States
(12) Patent Application Publication
(10) Pub. No.: US 2008/0235918 A1
(43) Pub. Date: Oct. 2, 2008

(54) Fastener

(76) Inventors: Laura Mooney, Carlstadt, NJ (US); Craig Hansen, Vancouver (CA)

Correspondence Address: KATTEN MUCHIN ROSENMAN LLP, 575 MADISON AVENUE, NEW YORK, NY, 10022-2585, US

(21) Appl. No.: 11/799,336

(22) Filed: Apr. 30, 2007

Related U.S. Application Data
(63) Continuation-in-part of application No. 29/285,586, filed on Apr. 2, 2007.

(51) Int. Cl. B65C 7/00; G09F 3/03

(52) U.S. Cl. 24/16 PB; 24/704.1

(57) ABSTRACT

A fastener for joining a first and a second article includes a head for being restrained by the first article and a retaining element having a first and second end point. The retaining element is inserted through the first and second article and is restrained by the second article. A filament connects the head and the retaining element and defines a first and second arm length of the retaining element from the respective first and second end point to the center-line of a root of the filament. The retaining element has a structure such that the first arm length is greater than the second arm length.

### CROSS-REFERENCE TO RELATED APPLICATIONS

This application is a continuation-in-part of and claims priority to U.S. Serial No. 29/285,586 filed on Apr. 2, 2007, which is pending and which is hereby incorporated by reference for all purposes.

### FIELD OF THE INVENTION

The present invention is directed to a fastener. In particular, the present invention is directed to a fastener having a retaining element and being advanced by a mechanical device to fasten a first article to a second article substantially without play.

### BACKGROUND OF THE INVENTION

U.S. Pat. No. 3,103,666 to Bone teaches a tagging attaching apparatus having a hollow needle to advance a portion of a fastening element, i.e. fastener, into an article of commerce, such as clothing to display a price tag and associated product information.

Housed on an assembly rod, i.e. pin tree, with other like fasteners, the fastener has a general H shape consisting of a bar that is inserted below a clothing layer and retains the fastener in the article. The bar is perpendicularly bisected by a filament. At an end distal from the bar, a flag is attached to the filament to keep a price tag or other information from sliding off.

To permit customers the opportunity to examiner the price tag and review any product information provided, the filament is significantly longer in proportion to the retaining element or the flag.

Today, these attaching apparatus are known generally in the art as tagging guns and have a shape and mechanical operation more consistent with those disclosed by now expired U.S. Pat. Nos. 4,090,653 and 4,187,970 to Furutu or U.S. Pat. No. 4,651,913 to Bone. Although, these patents disclose many improvements, the basic shape of the fastener continues to include a lower retaining element perpendicularly bisected by a long filament.

Subsequent improvements to fastening elements have focused on different configurations for highly specialized purposes including not just attaching articles loosely to each other but rather attaching articles substantially without play, i.e. with minimal movement.

For example, U.S. Pat. Nos. 6,047,823 to Deschenes et al. and 6,173,836 to Cooper et al. teach a fastening element having a retaining element, a filament, and a second retaining element to fasten sheets of paper together. While these patents also continue to teach a fastener having a retaining element that is perpendicularly bisected by the filament, the filament has a length that is significantly shorter than those disclosed by Furutu or Bone and more proportional to the length of the retaining element.

Indeed, for most usage, the structure of the fastener and the retaining element provides good results. The needle is inserted into the article to be tagged and held below a surface layer of the article. The trigger of the gun forces a push rod forward that separates the retaining element from its pin tree and advances the retaining element through the needle expelling it below the article's surface.

In expelling, the retaining element from the needle, the filament is substantially bent creating pressure on the leading half of the retaining element, as depicted in FIG. 9 of the '653 patent, shown herein as FIG. 3 (G being the clothing article, T being the tag being attached, P being the pin, 1 being the gun, and 3 being the needle). The forward movement of the leading half aids in expelling the lagging half of the retaining element.

However, when the articles are to be attached substantially without play, the short filament length limits its ability to develop sufficient momentum to expel the lagging half from the needle and the lagging half actually becomes bound in the needle. Fortunately, the gun and/or article maybe sufficiently jostled to expel a lagging portion of the retaining element when the articles being joined are flexible.

Unfortunately, when the articles or one of the article is not flexible, i.e. generally inflexible, the lagging portion of the retaining element often fails to expel even when given remedial measures. Thus, what is needed is a fastening element, i.e., fastener, which is suitable for attaching an inflexible article to another article.

All patents discussed in this application, including, but not limited to U.S. Pat. Nos. 3,103,666, 4,090,653, 4,187,970, 4,651,913, 6,047,823, are 6,173,836 are hereby incorporated by reference for all purposes.

### SUMMARY OF THE INVENTION

These and other needs are met by the present invention.

A fastener for joining a first and a second article includes a head for being restrained by the first article and a retaining element having a first and second end point. The retaining element is inserted through the first and second article and is restrained by the second article. A filament connects the head and the retaining element and defines a first and second arm length of the retaining element from the respective first and second end point to the center-line of a root of the filament. The retaining element has a structure such that the first arm length is greater than the second arm length.

A method of joining a first and second article substantially without play using a tagging gun includes selecting a fastener as described above and further selecting it based on criteria such as decorative head shape.

### BRIEF DESCRIPTION OF THE FIGURES

FIG. 1a is an isometric view of fasteners in accordance with one embodiment of the present invention.

FIG. 1b is a front view of the fastener of FIG. 1a.

FIG. 1c is a side view of the fastener of FIG. 1a.

FIG. 2 is a cross-sectional view of an inflexible article being joined to a second article 21 via a first and second fastener in accordance with one embodiment of the present invention.

FIG. 3 is a cross-sectional view of a fastener known in the art of being utilized with a tagging gun.

FIGS. 4a-4c are front views of fasteners in accordance with further embodiments of the present invention.

### DETAILED DESCRIPTION OF THE PRESENT INVENTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “attach,”“connect,” “couple,” and similar terms with their inflectional morphemes do not necessarily denote direct and immediate connections, but also include connections through mediate elements or devices.

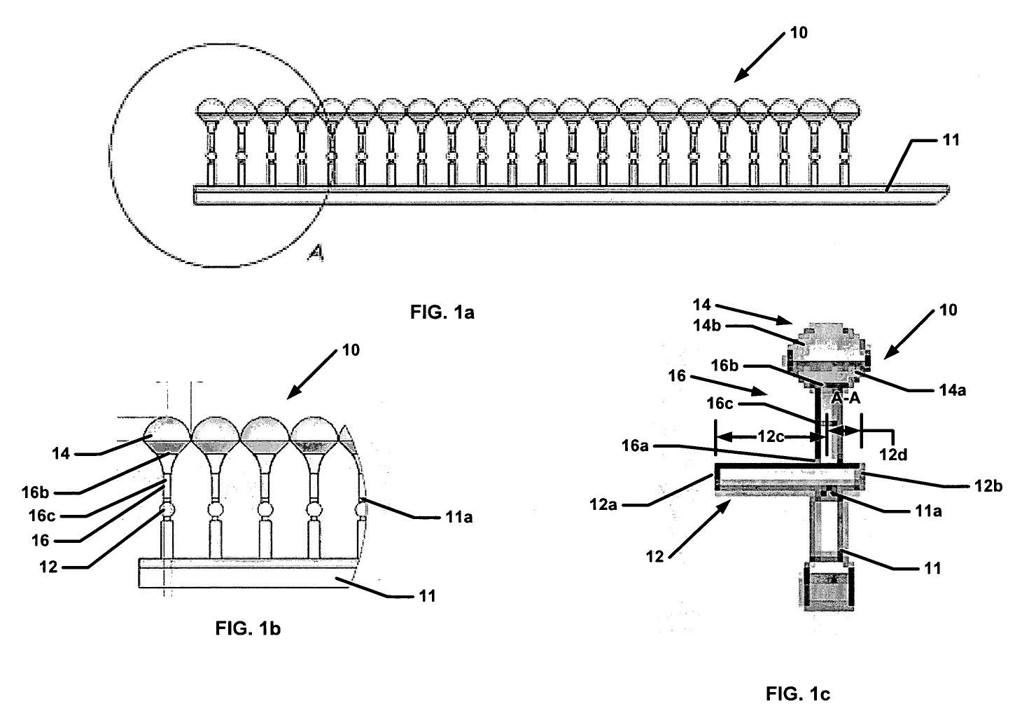

In accordance with one or more embodiments of the present invention, FIGS. 1a-1c illustrate a fastener 10 used for joining one or more articles to each other substantially without play. Preferably, one or more articles are generally inflexible.

Fastener 10 includes a first retaining element 12 joined at a root of filament 16 to a head 14. Fastener 10 may be made up of any suitable material, but preferably is made out of thermoplastic resin or polypropelene and may be made economically via extrusion or maybe injection molded as is generally known in the art.

Fastener 10 may be used alone or mounted on a pin tree 11 and being severable from the pin tree by a connector 11a. Fastener 10 and/or pin tree 11 are usable in mechanical tagging guns such as those disclosed in U.S. Pat. Nos. 4,090,653 and 4,187,970 to Furutu or U.S. Pat. No. 4,651,913 to Bone.

In cross-section, retaining element 12 is substantially circular to form a elongated cylindrical structure interrupted on a peripheral side by a filament 16. A distal end 12a and proximal end 12b are unevenly spaced from the filament or more particularly from a center line A-A of the root of filament 16.

When fastener 10 is used in a tagging gun, end 12a leads and end 12b lags and, thus, the retaining element comprises a leading arm 12c and a lagging arm 12d that is substantially shorter than the leading arm.

Head 14 may comprise any suitable size and shape that helps to restrain the fastener from being pulled out from a direction opposite that of the retaining element. In particular, head 14 may be shaped to have an engaging head portion 14a that engages and/or nests in one or more of the articles being joined. For example, the head portion may be shaped to engage an aperture in a button, i.e. a button hole. Since the head is often seen in certain applications, in combination with the head portion or alone the head may have a visible head portion 14b that has any suitable decorative shape desired.

Filament 16 comprises a root 16a that preferably widens towards the retaining element. The root is firmly attached or formed integral with the retaining element on a periphery of the retaining element so that the root is disposed substantially perpendicular to retaining element 12. Head 14 is joined to the filament at a distal end 16b of the filament.

The filament may have any suitable length that will preferably hold articles substantially without play. In cross-section, filament 16 may have any suitable shape, but preferably one that permits a central portion 16c of the filament to at least partially bend or distort to permit insertion of the retaining element.

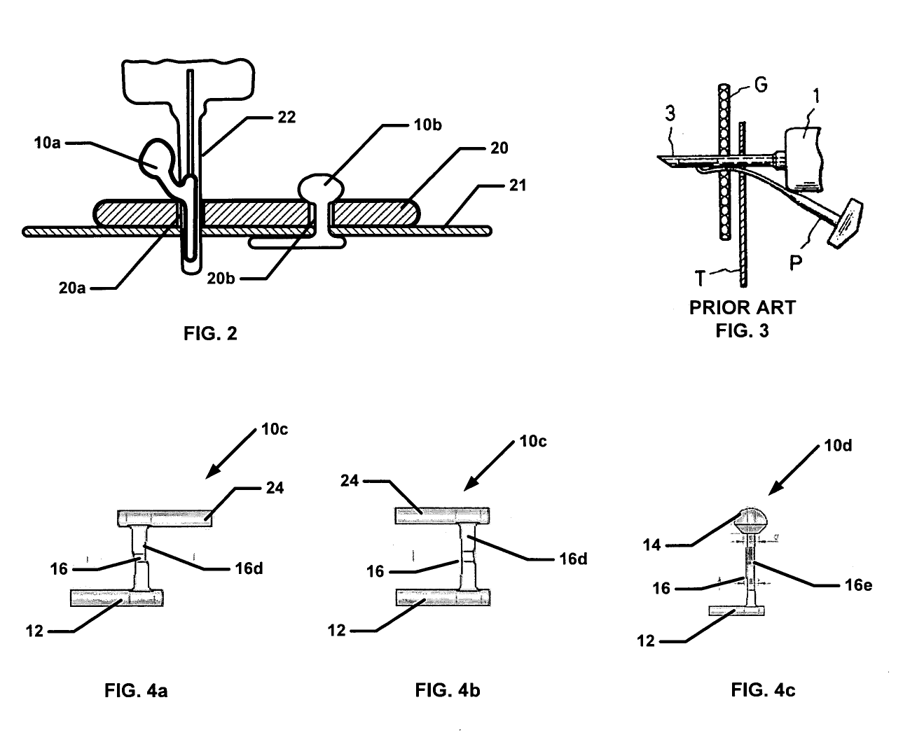

FIG. 2 is a cross-sectional view of an inflexible article 20 being joined to a second article 21, which may or may not be inflexible, via two fasteners 10, generally designated as 10a and 10b, respectively, being in an initial position and in a final position. As illustrated, the first fastener 10a is being placed with a needle 22 of a tagging gun as is known in the art through an aperture 20a of article 20. The second fastener 10b has already been placed in an adjacent aperture 20b to join articles 20 and 21 substantially without play.

Article 20 may be an item such as a button, an embellishment, a decoration or the like having a substantially rigid inflexible form. While article 21 may also be such an inflexible article, article 21 may be a portion of a garment (as shown here), a cloth, leather good, a flexible panel of a bag, or the like.

Preferably, the user has a plurality of fasteners in different sizes having different filament lengths, head sizes, and shapes available from which the user selects a fastener 10 that has a suitable filament length for joining the button to the garment substantially without play.

Herein, substantially without play means that the articles are joined and held relatively tightly together, but this does not mean that the articles cannot move relative to each other in any direction when joined. Thus, the user preferably determines a fastener having suitable dimension based on an inspection or experience with one or more articles 20, 21 or the like, and selects a fastener that has a filament length that is slightly larger than a thickness of the article or articles.

The user also preferably, has selected the fastener to have a head that has a suitable shape so as to press against at least a peripheral edge of an aperture of the button to resist pull-out of the fastener from the side of the retaining element.

Furthermore, the user may also select a suitable fastener 10 based on its aesthetic appeal, for example, a discreet rounded top that suits one or more of the articles being joined. Similarly, the user may select a suitable fastener based on its visual appeal.

In use, the pushrod, i.e. push pin of the tagging gun engages the lagging end 12b of the retaining element preferably in the center of the cross-sectional end area. The force applied by the pin frees the fastener from the pin tree at connection 11a and forces the retaining element into the needle.

Once the root of the filament engages a peripheral surface 20b of the aperture, the filament bends or distorts to permit the leading end of the retaining element to be inserted below article 21. When the head engages the peripheral surface, the continued force applied by the pushrod will force the leading arm from the needle. Because the lagging end is short, it will expel from the needle and not become bound. Thus, the articles are joined substantially without play.

In accordance with one embodiment of the present invention, fastener 10 may have a length of arm 12c from the distal end point 12a to the centerline A-A of root 16a is 3.5 mm and a length of arm 12d from the proximal end point 12b to the centerline A-A of root 16a is 1.0 mm. The filament has a width of 0.60 mm, the root has a maximum width of 1.2 mm and the head at the portion abutting the filament may be 1.2 mm. The head may have height of the engaging portion of 0.70 mm.

In accordance with other embodiments, suitable arm lengths may be as detailed in Table 1:

TABLE 1

| | Length of Arm 12c from the | Length of Arm 12d from the |
|---|---|---|
| | Distal End Point 12a to the | Distal End Point 12a to the |
| | Centerline A-A of Root 16a, | Centerline A-A of Root 16a, |
| Pair | in mm | in mm |
| 1 | 4.0 | 1.0 |
| 2 | 3.0 | 1.0 |
| 3 | 2.0 | 1.0 |
| 4 | 1.5 | 1.0 |
| 5 | 1.0 | 0.75 |
| 6 | 1.5 | 0.5 |
| 7 | 2.0 | 0.75 |
| 8 | 2.0 | 0.5 |
| 9 | 2.0 | 0.25 |

In fact, a ratio of suitable lengths of arms 12c to 12d, as defined above, has been found to be from 5.0:1.0 to 1.01:1.00. While the more equal arm lengths may be suitable in uses where the filament is long, the more unequal arm length are more suited in situation where the inflexible articles joined are thick and/or when the filament is relatively short. In such an instance, suitable dimensions of the fastener are detailed in Table 2.

TABLE 2

| | Length of Filament 16 from | |
|---|---|---|
| | intersection of the filament at | |
| | the root 12a with the retaining | Ratio of lengths |
| | element to the intersection at | of arms 12c to |
| Pair | end 16b, in mm | 12d, in mm |
| 1 | 2.6 | 3.5:1.0 |
| 2 | 2.9 | 3.5:1 |

In one or more embodiments of the present invention, a fastener 10c, having a structure generally as taught above, may include a head that may comprise a shape similar to the retaining element. Thus, a second retaining element 24 includes the structure of retaining element 12 and may have a similar or different orientation as depicted in FIG. 4a or 4b. Therein, filament 16 may or may not have a root 16d that attaches to the second retaining element.

In one or more embodiments of the present invention, a fastener 10d, having a structure generally as taught above, may include a central filament portion 16e that is elongated as depicted in FIG. 4c.

While the invention has been described in conjunction with specific embodiments, it is to be understood that many alternatives, modifications, and variations will be apparent to those skilled in the art in light of the foregoing description. For example, the order of the article may be changed, such that a flexible article layered on top of an inflexible article may be joined by the fastener of the present invention. Similarly, multiple layers sandwiching an inflexible article between flexible articles may be joined by the fastener of the present invention. Of course, flexible articles in themselves may also be joined by the fastener of the present invention.

What is claimed is:

1. A fastener for joining a first and a second article, the fastener comprising:
a head for being restrained by the first article;
a retaining element having a first and second end point, the retaining element for being inserted through the first and second article and being restrained by the second article;
a filament connecting the head and the retaining element, the filament defining a first and second arm length of the retaining element from the respective first and second end point to the center-line of a root of the filament;
wherein the first arm length is greater than the second arm length.

2. The fastener of claim 1, wherein a ratio of the first arm length to the second arm length is at least 1.01:1.0.

3. The fastener of claim 1, wherein a ratio of the first arm length to the second arm length is at least 2.0:1.0.

4. The fastener of claim 1, where the first arm length is at least 3.5 mm and the second arm length is at least 1.0 mm.

5. The fastener of claim 1, wherein a ratio of a length of the filament from an intersection of the filament at the root with the retaining element to an intersection with the head is 3.5:1.

6. The fastener of claim 1, wherein the filament has a length of the filament from an intersection of the filament at the root with the retaining element to an intersection with the head of 2.6 mm.

7. The fastener of claim 1, wherein the head comprises an engaging head portion for engaging the first article.

8. A fastener for a tagging gun, the fastener comprising:
a head for engaging a first article;
a retaining element for restraining against a second article, the second article being joined to the first article by the fastener;
a filament connecting the head and the retaining element, the filament defining a first and second arm;
wherein the first arm is longer than the second arm.

9. The fastener of claim 8, wherein the first arm is longer than the second arm length by a ratio of at least 1.01:1.0.

10. The fastener of claim 8, wherein the first arm is longer than the second arm length by a ratio of at least 2.0:1.0.

11. The fastener of claim 8, where the first arm is at least 3.5 mm and the second arm is at least 1.0 mm.

12. The fastener of claim 8, wherein the head has a decorative shape.

13. The fastener of claim 1, wherein the fastener is mounted on a pin tree.

14. The fastener of claim 8, wherein the filament has a length of the filament from an intersection of the filament at the root with the retaining element to an intersection with the head of 2.6 mm.

15. The fastener of claim 8, wherein the head comprises an engaging head portion for engaging the first article.

16. The fastener of claim 8, wherein the head comprises a shape identical to the retaining element.

17. A method of joining a first and second article substantially without play using a tagging gun;
the method comprising the steps of:
selecting a fastener having
head for being restrained by the first article;
retaining element having a first and second end point, the retaining element for being inserted through the first and second article and being restrained by the second article;
filament connecting the head and the retaining element, the filament defining a first and second arm length of the retaining element from the respective first and second end point to the center-line of a root of the filament;
herein the first arm length is greater than the second arm length,
pushing on a handle of the tagging gun;
inserting the fastener.

18. The method of claim 17, wherein the step of selecting the fastener further comprises determining a thickness of one of the first and second article and selecting a fastener having a filament length that is at least as great as the thickness of one of the first and second article.

19. The method of claim 17, wherein the step of selecting the fastener further comprises selecting the fastener based on a visible head portion of the head.

20. The method of claim 17, wherein the step of selecting the fastener further comprises selecting the fastener based on an engaging head portion of the head that engages the first article.

21. A fastener in combination with a first article for joining the first article and a second article, the fastener comprising:
a head for being restrained by the first article;
a retaining element having a first and second end point, the retaining element for being inserted through the first and second article and being restrained by the second article;
a filament connecting the head and the retaining element, the filament defining a first and second arm length of the retaining element from the respective first and second end point to the center-line of a root of the filament;
wherein the first arm length is greater than the second arm length.
